(19) United States
(12) Patent Application Publication
(10) Pub. No.: US 2014/0055804 A1
(43) Pub. Date: Feb. 27, 2014

(54) IMAGE PROCESSING APPARATUS, METHOD OF CONTROLLING THE SAME AND STORAGE MEDIUM THEREOF

(71) Applicant: CANON KABUSHIKI KAISHA, Tokyo (JP)

(72) Inventor: Kimimori Eguchi, Yokohama-shi (JP)

(21) Appl. No.: 13/911,883

(22) Filed: Jun. 6, 2013

(30) Foreign Application Priority Data
Aug. 22, 2012 (JP) 2012-183585

(51) Int. Cl. G06F 3/12

(52) U.S. Cl. CPC G06F 3/1222
USPC 358/1.14

(57) ABSTRACT

An image processing apparatus capable of communicating with a server that provides a microblogging function authenticates a user and acquires, in accordance with an authentication of the user, a message registered on the server by the authenticated user. The image processing apparatus determines whether or not the acquired message requests processing of image data, and in a case where the acquired message requests processing of the image data, the image processing apparatus processes the image data designated by the message.

### BACKGROUND OF THE INVENTION

1. Field of the Invention

The present invention relates to a technique in which a microblogging function provided by a service providing server is used by communicating with the server via a network.

2. Description of the Related Art

In recent years, there are services that provide a microblogging function as a communication tool. This microblogging function is a type of blog function by which a user holding an account posts short sentences called “microposts” as “messages” or “comments” to the service. Here the user may include, for example, an image forming apparatus itself, a linking service, an object on a cloud service or an application, and is not limited to an actually user (human). A unique identifier is assigned to each “message” and “comment” that a user posts or transmits. In the microblogging function, communication is carried out via a “timeline” or “following”. Here the “timeline” is a user specific Web page that registers, displays and manages, as a list, “comments” related to a registered “message”, when a user registers a “message”. Here, the user that registered the “message” and other users perform communication by exchanging information by registering information related to the message as “comments” on the “timeline”.

Also, “following” is registering for another user so as to be able to display on one's own Web page a message posted by the other user (hereinafter a user that follows is referred to as a follower).

Amongst CRM (Customer Relationship Management) services provided as cloud services, there are examples in which a microblogging function to be used as a communication tool during work is provided. In these cloud services, client information, business discussion information, etcetera is linked to “messages” and “comments” in order to further improve the user's convenience of use. Furthermore, at the same time, in CRM services, file sharing functions are provided in which files are shared between users, wherein the files can be saved, edited, updated, and referenced. An example of this is Chatter provided by Salesforce.com as a microblogging function. Document, File, etcetera are examples of file sharing functions.

Meanwhile, a technique in which when a user performs a print, after performing a print request, when it is desired that the print material be acquired, the user goes to the location of a print apparatus of his preference and carries out a print. For example, the user may make a request to print to a plurality of print apparatuses and dispatch a print job to a specific server. Meanwhile that server may dispatch a password to the user. Next, the user gets the desired print material by executing a print job on the print apparatus of his preference out of the plurality of print apparatuses by going to its location and inputting the password on that print apparatus (Japanese Patent Laid-Open No. 2003-345583).

However, with the conventional technique described above, because the requester of the print (user) had to receive a password from the server each time he dispatched a print job, and input it into the print apparatus of his preference, operation was cumbersome. Also, it was necessary to go to the trouble of transmitting a print job including data to be printed (hereinafter referred to as print data) to a specific server.

### SUMMARY OF THE INVENTION

An aspect of the present invention is to eliminate the above-mentioned problems with the conventional technology.

A feature of the present invention is to acquire from a server and print data on an image forming apparatus when a user simply authenticates, the user having registered a message including a print request command to the server using a microblogging function.

According to an aspect of the present invention, there is provided an image processing apparatus capable of communicating with a server that provides a microblogging function, the image processing apparatus comprising an authentication unit configured to authenticate a user an acquisition unit configured to acquire, in accordance with an authentication of the user by the authentication unit, a message registered on the server by the user authenticated by the authentication unit a determination unit configured to make a determination as to whether or not the message acquired by the acquisition unit requests processing of image data and a processing unit configured to process, in a case where the result of the determination by the determination unit is that the message acquired by the acquisition unit requests processing of image data, the image data designated by the message.

Further features and aspects of the present invention will become apparent from the following description of exemplary embodiments, with reference to the attached drawings.

### BRIEF DESCRIPTION OF THE DRAWINGS

FIG. 1 is a view for showing an overall configuration of a print system according to a first embodiment.

FIG. 2 is a block diagram for showing a hardware configuration of an image forming apparatus according to the first embodiment.

FIG. 3 is a block diagram for showing a configuration of a cloud service server according to the first embodiment.

FIG. 4 is a block diagram for explaining a software configuration of the image forming apparatus according to the first embodiment.

FIG. 5 is a block diagram for explaining a software configuration of the cloud service server according to the first embodiment.

FIG. 6 is a sequence diagram for explaining a processing sequence that the image forming apparatus, a terminal and the cloud service server execute according to the first embodiment.

FIG. 7 is a view for explaining a microblogging function provided by the cloud service server according to the first embodiment.

FIG. 8 is a flowchart for describing processing by the image forming apparatus according to the first embodiment of the present invention.

FIG. 9 is a flowchart for describing processing by the image forming apparatus according to a second embodiment of the present invention.

FIG. 10 is a flowchart for describing the details of search processing for the searching of a message including a print request by the image forming apparatus according to the first embodiment of the present invention.

FIG. 11 is a flowchart for describing processing of step S1003 of FIG. 10 by the image forming apparatus according to the second embodiment.

FIG. 12 is a view for explaining a print data management table for managing print data stored in a print data DB according to the first embodiment.

FIG. 13A is a view illustrating an example of a command character string management table.

FIG. 13B is a view illustrating an example of a parameter character string management table.

FIG. 14 is a flowchart for describing processing by the image forming apparatus according to a third embodiment of the present invention.

FIG. 15 is a view for showing an example UI screen displayed in the second embodiment.

### DESCRIPTION OF THE EMBODIMENTS

Embodiments of the present invention will be described hereinafter in detail, with reference to the accompanying drawings. Note that the following embodiments are not intended to limit the claims of the present invention, and that not all of the combinations of the aspects that are described according to the following embodiments are necessarily required with respect to the solution means of the present invention.

### First Embodiment

In the first embodiment, a user makes a request for a print with a microblogging function message, and after that goes to the location of an image forming apparatus 101 upon which he or she wishes to actually execute the print, and performs user authentication using the image forming apparatus 101. The case where the image forming apparatus 101 acquires print data provided by a server providing a microblogging function by searching messages and comments of the user for a print request and printing that print data will be explained. Also, in the first embodiment it will be assumed that there is only one print request included in the message. Also, it will be assumed that the image forming apparatus 101 is already in a relationship in which it is following the user.

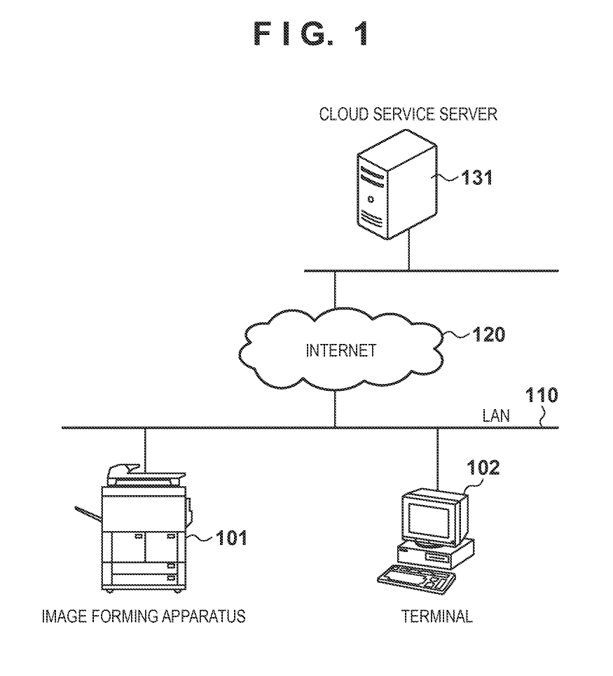

FIG. 1 is a view for showing an overall configuration of a print system according to the first embodiment.

In this system, the image forming apparatus 101 and a terminal 102 are connected by a LAN 110. Also, the LAN 110 is connected to the Internet 120, and a microblogging function providing cloud service server 131 is also connected to the LAN 110 via the Internet 120. Here the terminal 102 is connected to the LAN 110, but the present invention is not limited to this, and it is enough that the terminal 102 can connect to the cloud service server 131.

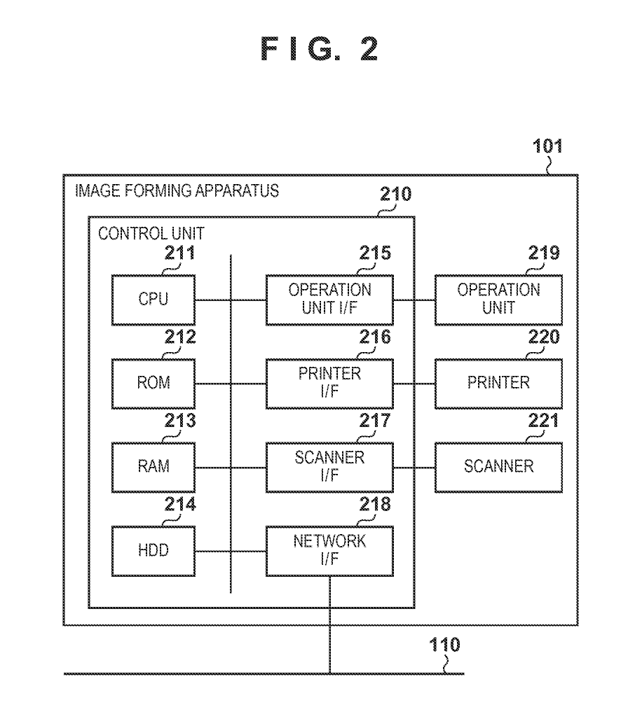

FIG. 2 is a block diagram for showing a hardware configuration of the image forming apparatus 101 according to the first embodiment.

The image forming apparatus 101 exemplifies an example of a multifunction peripheral having a print function, a scan function and the like. The image forming apparatus 101 provides, as a hardware configuration, a control unit 210, an operation unit 219, a printer 220 and a scanner 221. The control unit 210 comprises a CPU 211, a ROM 212, a RAM 213, an HDD 214, an operation unit I/F 215, a printer I/F 216, a scanner I/F 217 and a network I/F 218. The control unit 210, which includes a CPU 211, controls operation of the image forming apparatus 101 on the whole. The CPU 211 performs various control such as control of scanning of an original by the scanner 221, control of transmission of image data to the LAN 110, and print control using the printer 220 according to a control program loaded into the RAM 213 by a boot program in the ROM 212. The ROM 212 stores such things as a the boot program executed when the image forming apparatus 101 starts up and various settings. The RAM 213 is used as a temporary storage area such as a main memory and as a work area for the CPU 211.

The HDD 214 has on it installed an OS, and various programs for executing processing described with reference to the later explained flowcharts, and stores image data read in by the scanner 221, image data, and various information tables. The operation unit I/F 215 controls an interface between the operation unit 219 and the control unit 210. The operation unit 219 has an LCD unit (a display unit) having a touch panel function, a keyboard, or the like, and may also comprise a user authentication unit, or the like, for accepting user authentication when user authentication is performed with a card or the like. The printer I/F 216 connects the printer 220 and the control unit 210. Image data to be printed on the printer 220 is transferred from the control unit 210 to the printer 220 via the printer I/F 216, and printed by the printer 220 onto a recording medium (a sheet). The scanner I/F 217 connects the scanner 221 and the control unit 210. The scanner 221 reads in an image on an original, generates image data, and inputs it into the control unit 210 via the scanner I/F 217. The network I/F 218 connects the control unit 210 (the image forming apparatus 101) to the LAN 110. The network I/F 218 exchanges image data and various information via the terminal 102 on the LAN 110 and the Internet 120 with the cloud service server 131.

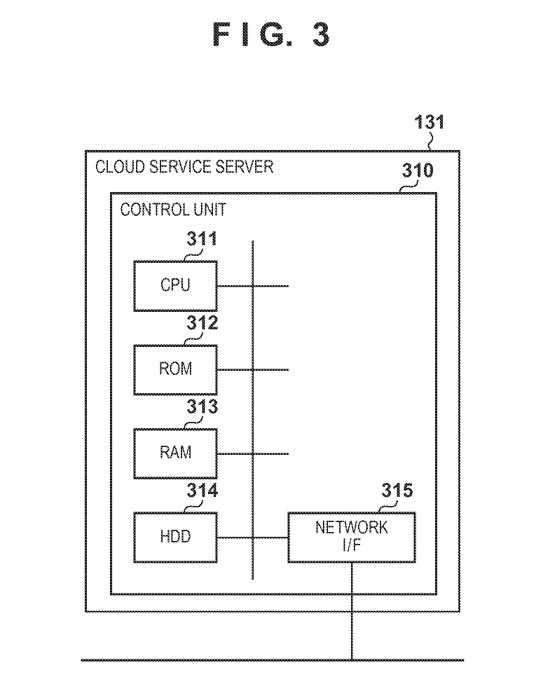

FIG. 3 is a block diagram for showing a configuration of the cloud service server 131 according to the first embodiment.

A control unit 310, including a CPU 311, controls operation of the cloud service server 131 on the whole. The CPU 311 executes various control processing according to a control program loaded into a RAM 313 by a boot program in a ROM 312. The RAM 313 is used as a main memory, a work area, or the like of the CPU 311. The HDD 314 has on it installed an OS, various programs, and the like, and these programs are loaded into the RAM 313 by a boot program in the ROM 312. Also, the HDD 314 stores image data and various kinds of later explained information tables, and the like. A network I/F 315 connects a control unit 310 (the cloud service server 131) to the Internet 120. Also, the network I/F 315 transmits and receives various information via the Internet 120 with other apparatuses on the LAN 110. Note, the configuration of the terminal 102 is the same as the configuration of the cloud service server 131 explained in FIG. 3.

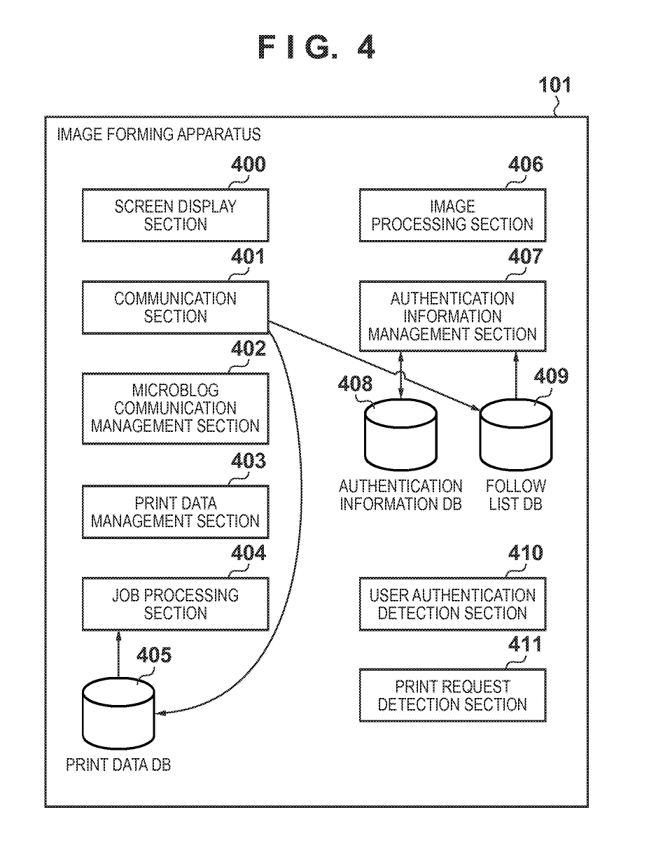

FIG. 4 is a block diagram for explaining a software configuration of the image forming apparatus 101 according to the first embodiment. The various functional sections shown in FIG. 4 are realized by the CPU 211 of the image forming apparatus 101 executing a control program loaded into the RAM 213.

The image forming apparatus 101 comprises an screen display section 400, a communication section 401, a microblog communication management section 402, a print data management section 403, a job processing section 404, a print data database 405, an image processing section 406, and an authentication information management section 407. Also, it comprises an authentication information database 408, a follow list database 409, a user authentication detection section 410 and a print request detection section 411. Note, hereinafter the print data database 405 will be abbreviated to the print data DB 405. Also, in the same way, the authentication information database 408 and the follow list database 409 will be abbreviated to the authentication information DB 408 and the follow list DB 409 respectively.

The communication section 401 transmits requests to the cloud service server 131 according to an instruction from the microblog communication management section 402. Also, the communication section 401 receives responses (a reply to the request) from the cloud service server 131. The communication section 401 acquires a list in which follow relationships are described from the cloud service server 131 and stores this list in the follow list DB 409.

After a user has performed a print request from, for example, the terminal 102, in a message on the microblog, the user performs authentication on the image forming apparatus 101 on which he or she wishes to actually print. The user authentication detection section 410 detects user authentication operation, and notifies the authentication information management section 407. Next, the authentication information management section 407 determines whether or not the user has usage permission for the image forming apparatus 101 by referencing the authentication information DB 408. In a case where the user has usage permission (when the user was authenticated), the authentication information management section 407 determines whether or not the user is a followed user by referencing the follow list DB 409. Next, when the image forming apparatus 101 determines that the user is a user that it is following, the communication section 401 transmits a request requesting messages of the user to the cloud service server 131 according to an instruction from the microblog communication management section 402.

With this, when the cloud service server 131 transmits the registered messages of the user, the communication section 401 receives the messages and displays the messages of the user being followed on a Web page of the image forming apparatus 101. Next, the print request detection section 411 determines whether or not the received messages include a print request command. If a message that includes the print request command is found, the storage location of the print data for which print was requested is determined, and sent in notification to the print data management section 403. With this, the print data management section 403 instructs the communication section 401 to acquire the print data from the cloud service server 131. In response to this, the communication section 401 acquires the print data that the user stored from the cloud service server 131, stores it in the print data DB 405 and notifies the job processing section 404 that the print data was stored.

The job processing section 404 performs print processing based on the print data stored in the print data DB 405. Next, the job processing section 404 notifies the microblog communication management section 402 to the effect that it performed the print processing. At this time, the screen display section 400 may display a screen for executing a print operation to the operation unit 210, make a request for an update in image processing, or the like, to the image processing section 406, according to an instruction from the user if necessary, and make a print job execution instruction to the job processing section 404. For example, the image processing section 406 accepts color processing and edge emphasis specification and update, as well as screen specification and update, and processes image data. When the print concludes in this way, the screen display section 400 displays that the print completed. Also, when the print completes, the microblog communication management section 402 instructs print completion notification of the cloud service server 131 by the communication section 401. This print completion notification is a message that informs a user that the print completed, and is text that a person can interpret such as, for example, “print completed”. Also, the microblog communication management section 402 performs management of messages that the image forming apparatus 101 transmitted to the cloud service server 131.

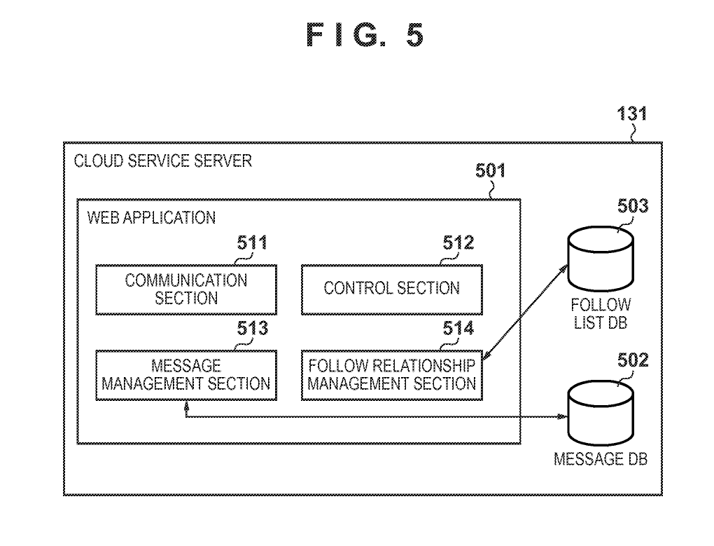

FIG. 5 is a block diagram for explaining a software configuration of the cloud service server 131 according to the first embodiment. The various functional sections shown in FIG. 5 are realized by the CPU 311 of the cloud service server 131 executing a control program.

The cloud service server 131 comprises a Web application 501, a message database 502 (hereinafter referred to as message DB 502), and a follow list database (follow list DB 503).

The Web application 501 is a Web application for providing a CRM service or the like. In the first embodiment, the microblogging function is provided in the Web application 501. The Web application 501 comprises a communication section 511, a control section 512, a message management section 513 and a follow relationship management section 514.

The communication section 511 receives a request from the image forming apparatus 101 or the terminal 102 (PC, etc.), and transmits that request information to the control section 512. Furthermore, the communication section 511 receives a processing result for the request from the control section 512, creates response data in response to the request, and transmits the response to the image forming apparatus 101 or the terminal 102.

The control section 512 extracts a message or comment included in the request according to the content of the request transmitted from the communication section 511 and makes a request to the message management section 513 for registration processing for the message or comment. The message management section 513 receives the message or comment transmitted from the control section 512 and stores it in the message DB 502. Also the message management section 513, upon request from the control section 512, acquires the message or comment registered in the message DB 502 from the message DB 502, and transmits it to the control section 512.

The follow relationship management section 514 manages the relationships of the followers and those who are followed. Specifically, for a case where the image forming apparatus 101 follows a particular user, when that user performs setting so that the image forming apparatus 101 follows the user, the image forming apparatus 101 makes a request to the communication section 511 so that the user be followed. Next the communication section 511 sends a notification of this to the follow relationship management section 514. With this, the follow relationship management section 514 adds to the follow list DB 503 something to the effect that the image forming apparatus 101 follows that user. With this a follow relationship is registered. Above is a explanation of registration of a follow, and the deletion of a follow relationship is executed by similar steps.

Also, the case where a user follows the image forming apparatus 101 is performed similarly. Specifically, the user makes a request to follow the image forming apparatus 101 to the communication section 511 using the terminal 102 (PC, etc.). The communication section 511 notifies the follow relationship management section 514 of this, and the follow relationship management section 514 adds to the follow list DB 503 that the user follows the image forming apparatus 101.

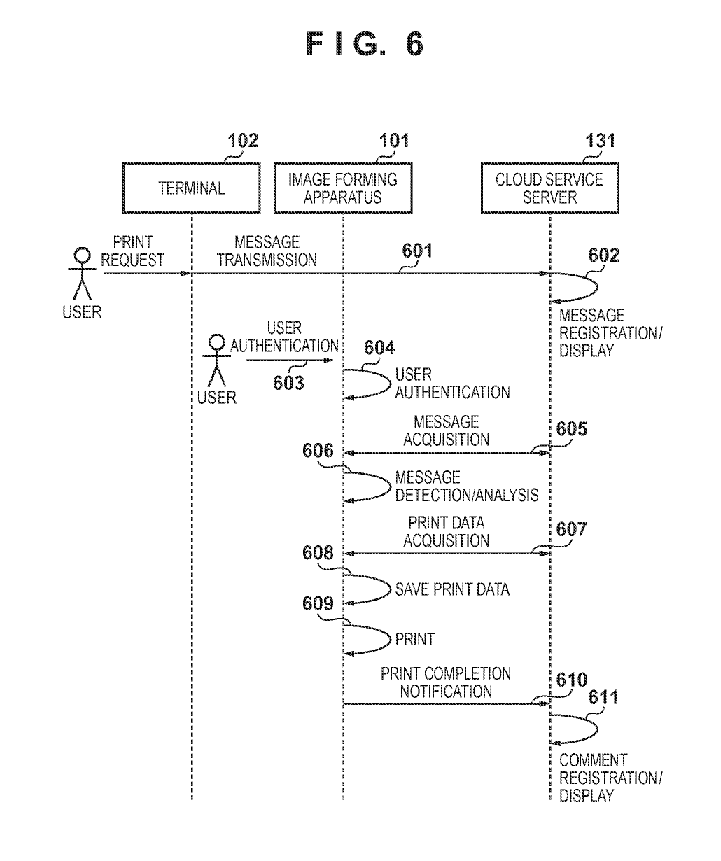

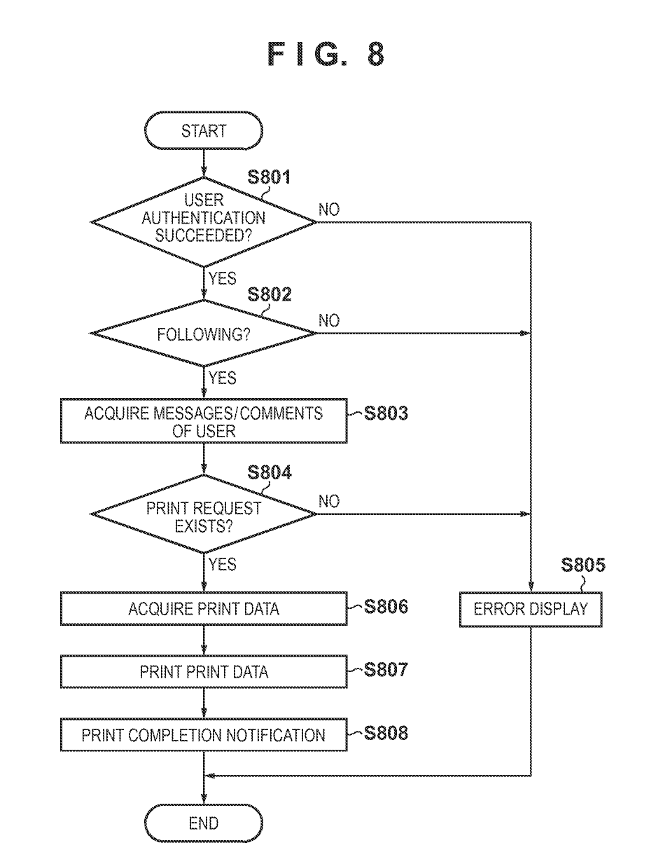

FIG. 6 is a sequence diagram for explaining a processing sequence that the image forming apparatus 101, the terminal 102 and the cloud service server 131 execute according to the first embodiment of the present invention. Note, the details of the processing of the image forming apparatus 101 will be explained later with reference to the flowchart of FIG. 8.

Firstly, in numeral 601, the user accesses the cloud service server 131 using a Web browser of the terminal 102 (PC etc.) and transmits a message such as, for example, “please print 2 copies of PROJECT_Y-RESOURCE_MANAGEMENT.xls”. With this the cloud service server 131, in numeral 602, receives the message that the user transmitted, and along with registering the message to the message DB 502, it displays it to a Web page. Next, in numeral 603, the user goes to the location of the image forming apparatus 101 on which the user would like to actually execute the print, and performs user authentication using the image forming apparatus 101.

In numeral 604, the image forming apparatus 101 determines whether or not the user is authenticated and whether or not the user is a user it is following. If the user authentication succeeded, the image forming apparatus 101, in numeral 605, makes a request to the cloud service server 131 for messages that the user has registered, and the acquires the messages. Next, in numeral 606, the image forming apparatus 101 analyzes a message acquired in numeral 605, and determines from the content of the message whether or not it is a message that contains a print request. If it is a message that includes the print request, it analyzes the storage location of the print data for which the print request was made. Here, analysis of a plurality of messages of the user is made in order from the newest to the oldest. Next, in numeral 607, the image forming apparatus 101 makes a request for print data to the cloud service server 131 based on the analysis result of the message, and acquires the print data. Here the file “PROJECT_Y-RESOURCE_MANAGEMENT.xls” is acquired. Next, the processing proceeds to numeral 608, and the image forming apparatus 101 saves the print data acquired in numeral 607 to the print data DB 405. Next, in numeral 609, the image forming apparatus 101 prints two copies of the print data saved in the print data DB 405 in numeral 608.

When the print completes, the image forming apparatus 101 transmits to the cloud service server 131 a comment (print completion notification) to the effect that “the print completed” in numeral 610. In numeral 611, the cloud service server 131 registers in the message DB 502 and also displays on the Web page that comment.

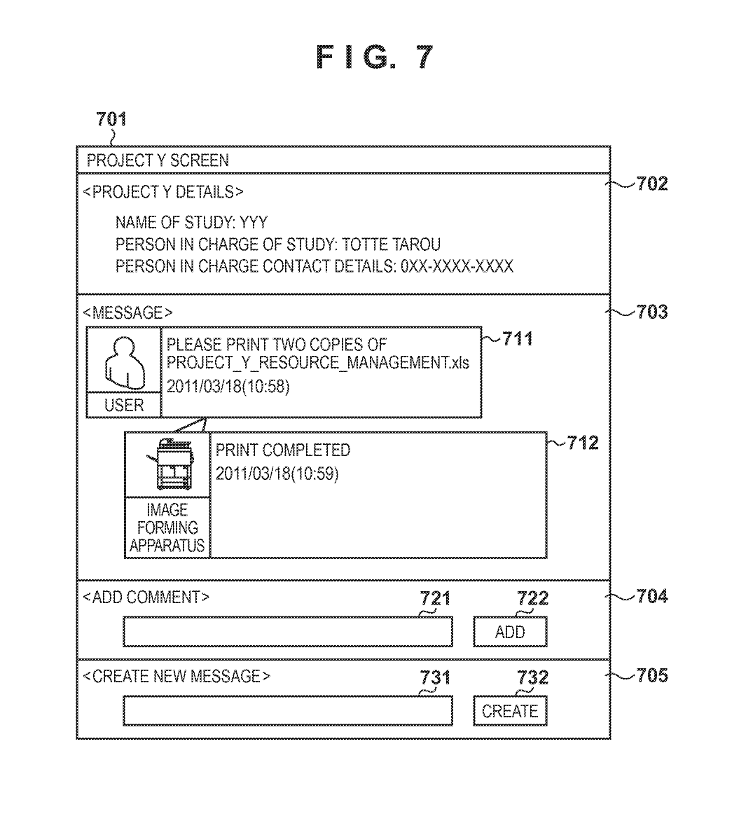

FIG. 7 is a view for explaining a microblogging function provided by the cloud service server 131 according to the first embodiment of the present invention. FIG. 7 shows a example of a Web page displayed on the terminal 102 by accessing the cloud service server 131 from a Web browser operating on a terminal 102 such as a PC or a mobile terminal.

Here, the cloud service server 131 is managing a currently in progress project for the purpose of development support. Numeral 701 denotes an example display of a project Y screen that displays information relating to the currently in progress project. A project details area 702 is showing information related to this project Y such as a name of a study, a person in charge the study, and contact details for the person in charge of the study.

The message display area 703 displays messages and timelines comprising comments to the messages. In the message display area 703, the user has registered a message 711 that states, “please print two copies of PROJECT_Y-RESOURCE_MANAGEMENT.xls”. It can be seen that next, in response to the message 711, the image forming apparatus 101 has registered a comment 712 that states, “print completed”. Here, the image forming apparatus 101 is in a relationship where it is following the user. When the user goes to the image forming apparatus 101 and makes a setting so that the user be followed, the image forming apparatus 101 will then follow that user. With this, the image forming apparatus 101 can display the message 711 that the user posted on a Web page specific to the image forming apparatus 101. Next, by analyzing the message 711 posted by the user, the image forming apparatus 101 can determine whether or not the user message 711 includes a print request. Also, it is assumed that print data or link information for the “PROJECT_Y-RESOURCE_MANAGEMENT.xls” included in the message 711 is provided. The storage destination of the print data may be the cloud service server 131 or an external server (not shown). In this way, the image forming apparatus 101 can acquire the print target file (print data) from the cloud service server 131. Also, here an example is shown in which an Excel (registered trademark) file is shown, but this may be a document file such an Adobe PDF (registered trademark) or a Word (registered trademark) file.

When the user inputs a comment into the comment input field 721 and clicks the add button 722 in the comment input area 704, a comment add request is transmitted from the Web browser of the terminal 102 to the cloud service server 131. The cloud service server 131, having received this request, registers the comment input into the comment input field 721 on the cloud service server 131.

With this, when the user accesses the cloud service server 131 with the Web browser of the terminal 102, this registered comment is displayed on the Web browser of the terminal 102 as with the previous described comment 712. Also, when the user inputs a message into the message input field 731 and presses the create button 732 in the message input area 705, a message creation request is transmitted from the Web browser of the terminal 102 to the cloud service server 131. The cloud service server 131, having received this request, registers the input message on the cloud service server 131.

With this, when the user accesses the cloud service server 131 with a Web browser on the terminal 102, the created message is displayed on the Web browser of the terminal 102 as with the previously described message 711.

FIG. 8 is a flowchart for describing processing by the image forming apparatus 101 according to the first embodiment of the present invention. Note, the program that executes this processing is installed in the HDD 214, loaded into the RAM 213 at execution time, and executed under the control of the CPU 211.

Firstly, in step S801, the CPU 211 performs user authentication. Specifically, when the user authentication detection section 410 detects authentication operation by a user, it notifies the authentication information management section 407 that user authentication was instructed.

The authentication information management section 407 determines whether the user authentication succeeded by comparing the user information that the user input against the information of the authentication information DB 408. In other words, it determines whether or not the user has usage rights for the image forming apparatus 101. When the result of the determination is that the authentication succeeded because the user is registered in the authentication information DB 408, the processing proceeds to step S802, and when the authentication fails, the processing proceeds to step S805 and an error is displayed. In step S802, the CPU 211 determines whether or not the user is a user that the image forming apparatus 101 is following. Specifically, the authentication information management section 407 of the image forming apparatus 101 determines whether or not the user is a user it is following by referring to the follow list DB 409.

If the result of this determination is that it is not following the user, the processing proceeds to step S805, and an error is displayed. If the user is a user it is following, the processing proceeds to step S803. In step S803, the CPU 211 acquires messages or comments of the user from the cloud service server 131. Specifically, the communication section 401 of the image forming apparatus 101 transmits a request requesting messages that the user registered to the cloud service server 131 according to an instruction from the microblog communication management section 402.

With this, the messages of the user that the image forming apparatus 101 follows are displayed on a Web page specific to the image forming apparatus 101. Next, the processing proceeds to step S804, and the CPU 211 searches for a print request message from out of the acquired user messages. Specifically, the print request detection section 411 of the image forming apparatus 101 searches for a message containing a print request.

Here, in a case where there is no print request in the received messages, the processing proceeds to step S805, and the CPU 211 performs error display or error notification. Specifically, the image display section of the image forming apparatus 101 displays an error. Regarding the content of the error display of step S805, if error display is the result of step S801, the screen display section 400 displays content stating, for example, “The user could not be authenticated. Please contact the administrator”. Also, if error display is the result of step S802, the screen display section 400 displays a follow registration screen stating, for example, “Not registered to follow Mr. XX. Please register the follow relationship”. Also, if error display is the result of step S804, the screen display section 400 displays a message stating, for example, “Could not find a print request from Mr. XX. Please confirm that the access destination is correct”. Next, a UI for inputting the access destination is prepared and this processing concludes. On the other hand, when, in step S804, a message including the print request is found, the processing proceeds to step S806, and the CPU 211 acquires print data that the user stored from the cloud service server 131. Next, the print request detection section 411 of the image forming apparatus 101 determines the storage location of print data of the user and notifies the print data management section 403.

With this, the print data management section 403 indicates acquisition of the print data to the communication section 401, and the communication section 401 acquires the print data from the location in which the user stored it on the cloud service server 131 and stores the print data in the data DB 405.

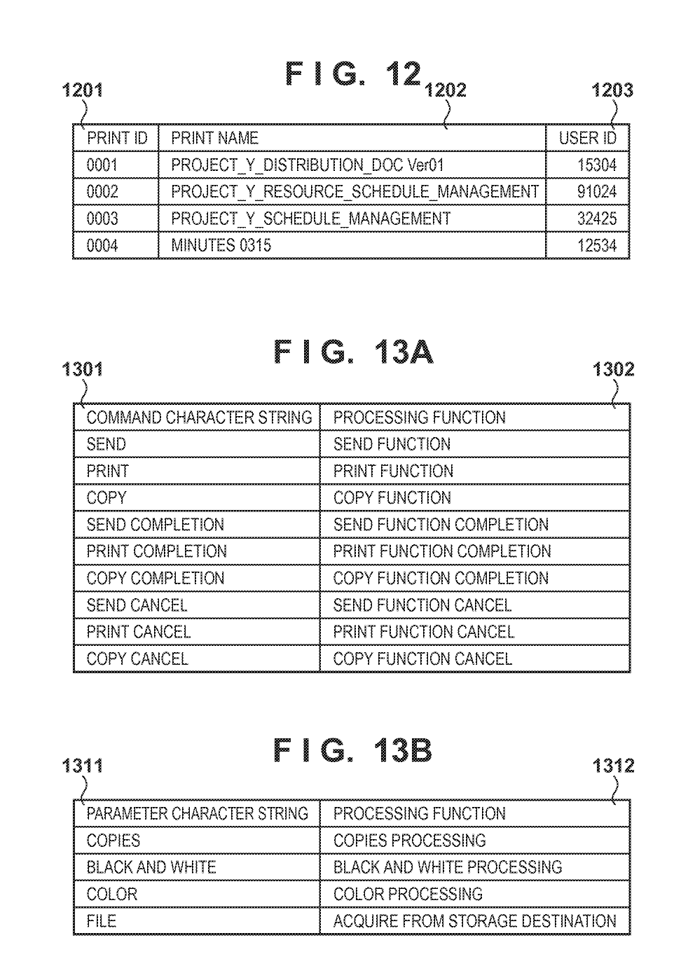

FIG. 12 is a view for illustrating an example of a print data management table for managing print data stored in a print data DB according to the first embodiment. This print data management table is generated and managed by the print data management section 403.

A print ID 1201 is an identifier of the print data and does not overlap in the print data management table. A print name 1202 stores a character string indicating a name of a document file of the print target included in the message that includes the print request that is analyzed in step S804.

Also, a user ID 1203 is registered based on information of the user that dispatched the message including the print request that was analyzed in step S804. When print data is stored in the print data DB 405 in this way, the print data management section 403 sends a notification to the job processing section 404 to the effect that the print data was stored. Next, the processing proceeds to step S807, and the CPU 211 reads out print data from the print data DB 405, and prints by outputting it to the printer 220 via the printer I/F 216.

Specifically, the job processing section 404 executes print processing based on the print data stored in the print data DB 405. After printing of the print data has finished in this way, the processing proceeds to step S808, and the CPU 211 notifies the cloud service server 131 of print completion (print completion notification) and also displays to the UI. In other words, the job processing section 404 notifies the microblog communication management section 402 that the print completed.

Next the communication section 401 sends in notification a print completion notification to the cloud service server 131 according to an instruction from the microblog communication management section 402. Meanwhile, the screen display section 400 displays print completion notification.

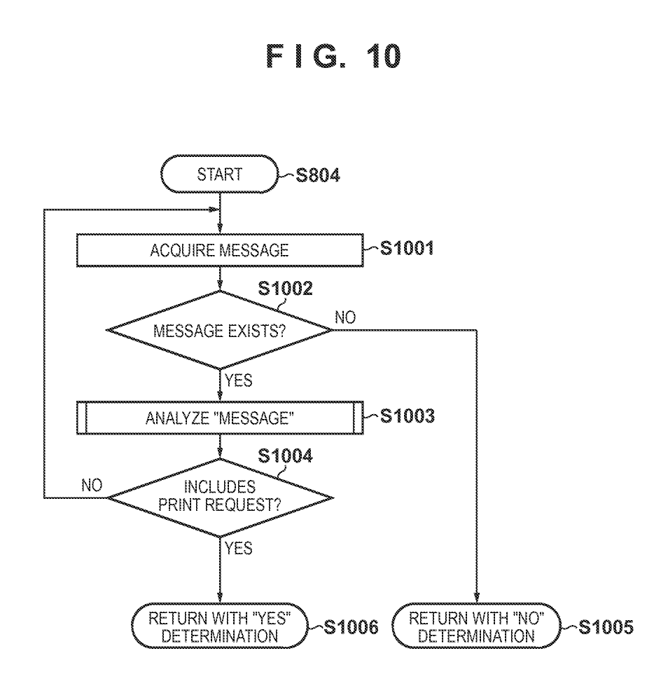

FIG. 10 is a flowchart for describing the details of search processing (step S804) for the searching of a message including a print request by the image forming apparatus 101 according to the first embodiment of the present invention. Firstly, in step S1001, the CPU 211 extracts any messages acquired from the cloud service server 131 via the communication section 401.

Here, the CPU 211 attempts to extract a single message from the messages extracted in step S1001.

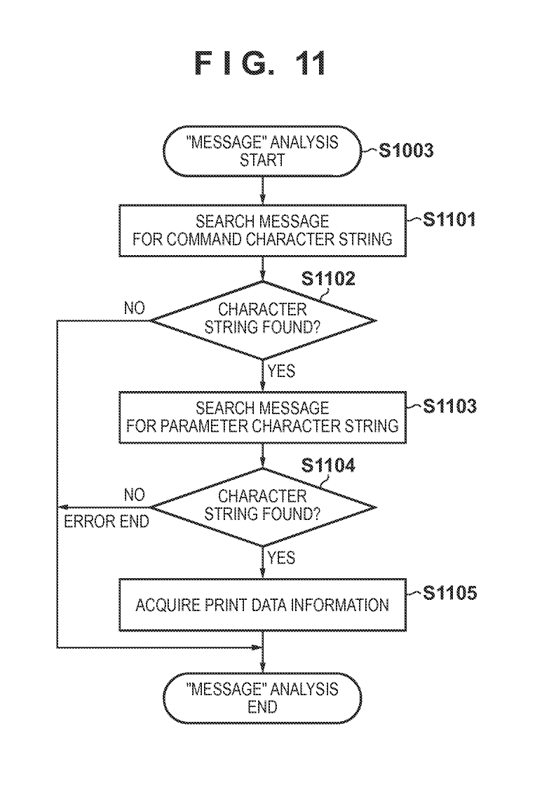

Next, the processing proceeds to step S1002, and determination is made of whether or not the message exists. In the case where the message does exist, the processing proceeds to step S1003, and in the case where the message does not exist, processing proceeds to step S1005 in order to display a something to indicate that even though all of the message of the user were examined, there was no print request, and processing returns to the main routine with the determination result being “NO”. In step S1003, the contents of the message acquired in step S1002 are analyzed, and it is determined whether or not a print request command is included. This message analysis processing will be explained in detail later with reference to FIG. 11.

Next, the processing proceeds to step S1004, and determination is made as to whether or not the result of the analysis processing of step S1003 was that the message includes a print request command. In a case where the message does include the print request command, the processing proceeds to step S1006 and completes with the determination result being “YES”, and in a case where the message does not include the print request command, the processing proceeds to step S1001.

FIG. 11 is a flowchart for describing the details of the message analysis processing of step S1003 of FIG. 10 by the image forming apparatus 101 according to the second embodiment of the present invention. FIGS. 13A and 13B are views illustrating examples of a command character string management table and a parameter character string management table respectively.

In the flowchart of FIG. 11, the microblog communication management section 402 analyzes the message read out in step S1002. The message may be, for example, described in the following format.

“Please print two copies of PROJECT_Y-RESOURCE_MANAGEMENT.xls”.

The microblog communication management section 402 determines whether or not the print request command is included in the message, and furthermore, it determines the settings such as the print data that is the target of the print request, the print data storage location, and the number of copies to print. Detailed explanation will be given below.

Firstly, in step S1101, the microblog communication management section 402 searches to determine whether a command character string 1301 of a command character string management table is included in the message. In step S1102, based on the search result of step S1101, it is determined whether or not a character string indicating the command is included in the message.

In a case where the character string indicating the command in step S1101 was found, the processing proceeds to step S1103, and in a case where the character string was not found, the flow completes in error because the comment cannot be processed. In the case of the aforementioned message, because the character string “print” is included, it can be determined from the command character string management table of FIG. 13A that a processing function 1302 of the command “print” is the print processing function. In a case where a character string indicating a command was found, the microblog communication management section 402, in step S1103, searches to determine whether or not the character string included in a parameter character string 1311 of the parameter character string management table of FIG. 13B is included in the message.

In step S1104, it is determined whether or not a parameter character string is included in the message based on the search result of step S1103. In step S1104, in a case where a parameter character string is found to be in the message, the processing proceeds to step S1105, and in a case where, in step S1103, a parameter character string was not found, the flow completes in error because the comment cannot be processed. In the case of the aforementioned message, because “two copies” can be found, it is determined that a parameter character string was found, and it can be determined that the number of copies to be processed is two copies from a processing function 1312 corresponding to FIG. 13B. In this way, by the processing from step S1102 to S1104, it can be determined that the message is instructing that print processing for two copies of the document file “PROJECT_Y-RESOURCE_MANAGEMENT.xls” be performed.

Next, in step S1105, the storage information of the print data found in step S1104 is acquired. Accordingly, in the case of the aforementioned message, it is determined that the message does include the print request command in step S804 of FIG. 8, and based on the storage information of the print data acquired in step S1105 of FIG. 11, print data is acquired from the cloud service server 131. As explained above, with the first embodiment, a user can print a target print file on an image forming apparatus of his preference by simply including the print target file and a print request in a message of a microblogging function and registering it, and performing user authentication on the image forming apparatus.

For this reason, there is the effect that the user can print a file of his preference on the image forming apparatus of his preference, and acquire the print material without having to do any cumbersome work.

In contrast, in the case of a print environment in which a user requested a print with a microblogging function message and an image forming apparatus 101 monitors for this request and carries out a print, it is necessary for a plurality of image forming apparatuses to continuously monitor for comments of followed users.

However, with the first embodiment, simply by the user performing user authentication on the image forming apparatus 101, the image forming apparatus 101 acquires the messages from the cloud service server 131 and searches for the user's print request. Then, in the case where a message includes the print request, the image forming apparatus 101 can acquire the requested document file (print data) from the cloud service server 131 and print it. Accordingly, there is no need for a plurality of image forming apparatuses to constantly monitor for cloud service server 131 messages. Because of this, it is possible to suppress the increase in load due to a plurality of image forming apparatuses accessing the cloud service server 131, and the increase in load due to analysis of messages and comments. Furthermore, because excessive access to the cloud service server 131 can be restricted, there is an effect in terms of compliance to access restriction to the cloud service server 131.

### Second Embodiment

In the first embodiment, a user performed a single print request. In contrast to this, in the second embodiment, explanation will be given of the case where a user makes a plurality of print requests. Here, only parts that differ from the first embodiment will be explained, and because the method of searching for a message or comment, and the method of analyzing are the same as in the first embodiment, these will not be described here. Also, the system configuration of FIG. 1, and the configurations of the image forming apparatus 101, and the cloud service server 131 are the same as in the previously described first embodiment and so explanation of these will be omitted.

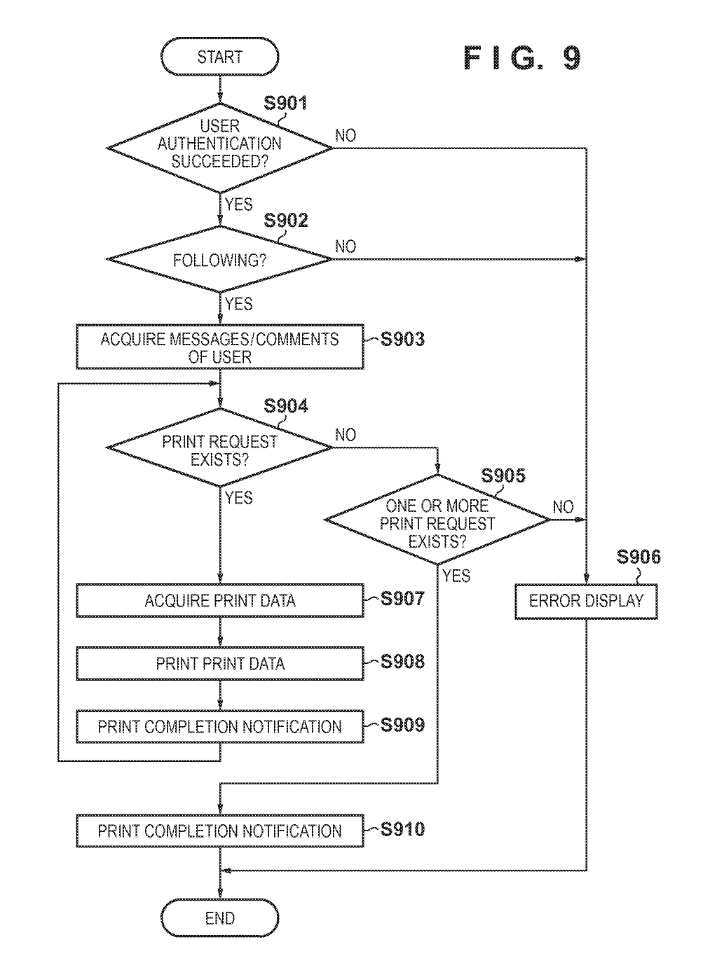

In the second embodiment, comparing with the first embodiment, because the processing after a print request of a message is found and printed is different, explanation is made using FIG. 9 only.

FIG. 9 is a flowchart for describing processing by the image forming apparatus 101 according to the second embodiment of the present invention.

Note, the program that executes this processing is installed in the HDD 214, loaded into the RAM 213 at execution time, and executed under the control of the CPU 211. Steps S901 through S903 of FIG. 9 are the same as steps S801 through S803 in previously described FIG. 8.

In step S901, the CPU 211 performs user authentication. Specifically, the user authentication detection section 410 of the image forming apparatus 101 notifies the authentication information management section 407 when user authentication operation is detected, the authentication information management section 407 compares against the authentication information DB 408, and determines whether or not that user was successfully authenticated for the image forming apparatus 101. If the result of this determination is that the user authentication failed, the processing proceeds to step S906, and if the authentication succeeds, the processing proceeds to step S902. In step S902, the CPU 211 determines whether or not the image forming apparatus 101 is following the user. Specifically, the authentication information management section 407 of the image forming apparatus 101, referring to the follow list DB 409, determines whether or not the image forming apparatus 101 is following the user. If the result of this determination is that the user is not being followed, the processing proceeds to step S906, and if the user is being followed, the processing proceeds to step S903.

In step S903, the CPU 211 acquires from the cloud service server 131 the messages or comments of the followed user. Specifically the communication section 401 of the image forming apparatus 101 transmits a request requesting acquisition of the messages of the user to the cloud service server 131 according to an instruction from the microblog communication management section 402. With this the messages of the followed user are displayed on a Web page of the image forming apparatus 101.

Next the processing proceeds to step S904, and the CPU 211 searches the user messages acquired in step S903 for a message containing a print request command. Specifically the print request detection section 411 of the image forming apparatus 101 searches the messages for a print request command. If there is the print request command in these received messages, print processing is performed in steps S907 through S909. If there is no more print request commands in the messages received in step S904, the processing proceeds to step S905. In step S905, the CPU 211 checks whether there was one or more print requests. Specifically, the print request detection section 411 of the image forming apparatus 101 searches for a print request command from among the user messages, and at the same time counts the number of occurrences of the print request command. In the case where not a single print request is found, a error to this effect is displayed. If a print request was found, something to the effect that detected print requests will be executed is displayed. Accordingly, if there is not a single print request, the processing proceeds to step S906, and if there is one or more print requests, the processing proceeds to step S910. In step S906, the CPU 211 displays an error. Specifically, screen display section 400 of the image forming apparatus 101 displays the error. In this case, if the content to be displayed is an error display based on the result of step S901, content to the effect of “the user could not be authenticated” is displayed. Also, if the error display is based on the result of step S902, content to the effect of “Following of Mr. XX has not been registered. Please register the follow.”, for example, is displayed, and transition to a follow registration screen is made. Also, if error display is performed based on a result of step S905, content to the effect of “Mr. XX's print request could not be found. Please confirm that the access destination is correct.” is displayed, a UI by which an access destination can be entered is prepared and this flow completes. In step S907, the CPU 211 acquires print data that the user registered from the cloud service server 131. Specifically the print request detection section 411 of the image forming apparatus 101 determines a storage location of the print data of the user on the cloud service server 131, and notifies the print data management section 403.

With this, the print data management section 403 instructs the communication section 401 to acquire the print data, and the communication section 401 acquires the print data from the location in which the user stored it on the cloud service server 131. Print data acquired in this way is stored in the print data DB 405, and notification to the effect that storage was made is made to the job processing section 404. Next, the processing proceeds to step S908, and the CPU 211 reads out the print data from the print data DB 405, and outputs it to the printer 220. Specifically, the job processing section 404 performs a print based on the print data stored in the print data DB 405.

Next, the processing proceeds to the step S909 and the CPU 211 displays to the UI that printing has completed when the print processing completes. Specifically, the job processing section 404 notifies the microblog communication management section 402 of print completion. Next the microblog communication management section 402 instructs the communication section 401 to notify the cloud service server 131 of print completion, and the screen display section 400 displays that the print completed. Next, the processing proceeds to step S904, and search to determine whether another print request command exists is made. Meanwhile, in a case where there is one or more print request commands in the received messages in step S905, the processing proceeds to step S910 and the CPU 211 displays that all of the print requests instructed in those messages have completed. Specifically, the screen display section 400 of the image forming apparatus 101 displays that all of the print requests of the messages have completed.

Also, the microblog communication management section 402 instructs the communication section 401 to notify the cloud service server 131 to the effect that all of the print requests of the messages have completed. As explained, by the second embodiment, it becomes possible to process a plurality of print requests included in the messages. In the second embodiment, when a print request command is found in the messages, search for a print request command in another message may then be performed, and based on print data requested by these print request commands, print may be performed.

Next, if print has completed for the print request command, notification to the cloud service server 131 that the printing completed is made as a comment made in response to the message.

Note, here an example was shown in which completion message notification is made upon each completion print of print data, but print notification may be made in a single notification after completion of print processing for all of the print requests. Also, in a case where printing is carried out for a plurality of print requests as in the second embodiment, there may be cases were there are files that the user does not wish to print. In these cases, in step S904 of FIG. 9, the following processing is performed.

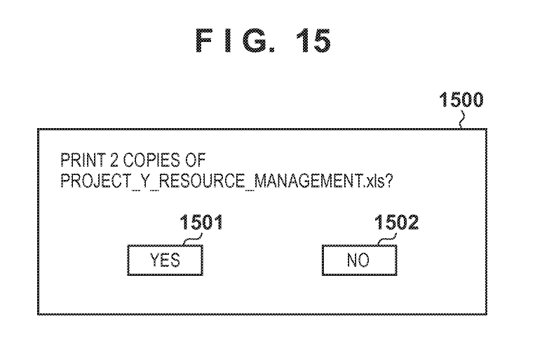

Specifically, in step S904, the image forming apparatus 101 searches for a message that includes a print request command from out of the acquired user messages. Specifically, the print request detection section 411 of the image forming apparatus 101 determines whether or not there is a print request command in the messages. When there is no print request command in the received messages, the processing proceeds to step S905. On the other hand, in a case where there is a print request command, in step S904, the screen display section 400 of the image forming apparatus 101 displays a UI as shown in FIG. 15.

FIG. 15 is a view for showing an example UI screen displayed in the second embodiment. Here a print data name corresponding to a print request command name included in a message is displayed to a UI 1500.

Next, a button “YES” 1501 that instructs print execution and a button “NO” 1502 that instructs print execution cancellation are displayed.

Whether or not to print the print data is determined according to which of these buttons is selected by the user. Specifically, in a case where the user selects “YES” 1501, processing proceeds from step S904 to step S907 in FIG. 9, and in a case where the user selects “NO” 1502, the processing proceeds from step S904 to step S905.

### Third Embodiment

When messages are analyzed one at time, regardless of whether there is a print completion comment for a print request included in a message, the message may be once again taken as a print request, and print processing may be undesirably executed again due to this print request.

So, in the third embodiment, in a case where there is a print request command in the message, comments for that message are analyzed, and by analyzing whether or not the print request has been completed, the above problem is solved. Here, a plurality of the image forming apparatuses 101 are in follow relationships with each other, and comments for print completion made in notification by other image forming apparatuses 101 can be seen from a Web page of the image forming apparatus 101. Here, only parts that differ from the first embodiment will be explained, and because the method of searching for a message or comment, and the method of analyzing are the same as in the first embodiment, these will not be described here.

Also, the system configuration of FIG. 1, and the configurations of the image forming apparatus 101, and the cloud service server 131 are the same as in the previously described first embodiment and so explanation of these will be omitted.

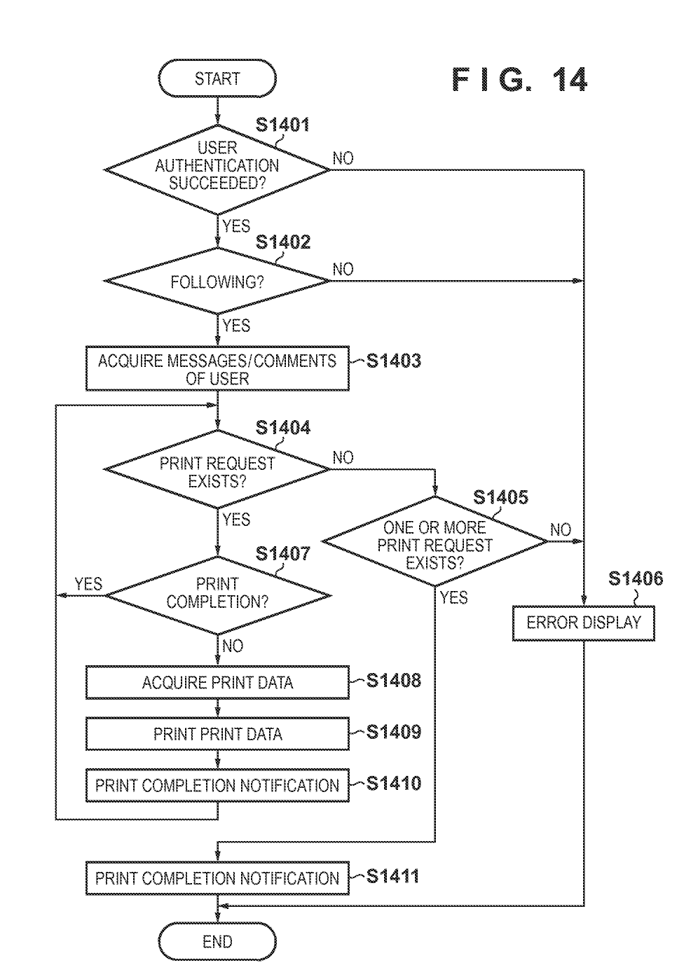

FIG. 14 is a flowchart for describing processing by the image forming apparatus 101 according to the third embodiment of the present invention.

Firstly, in step S1401, the CPU 211 performs user authentication. Specifically, when the user authentication detection section 410 detects authentication operation by the user, it notifies the authentication information management section 407 that user authentication was instructed.

The authentication information management section 407 determines whether the user authentication succeeded (in other words whether the user has usage permission for the image forming apparatus 101) by referencing the authentication information DB 408. If the result of this determination is that the authentication succeeds because the user is registered in the user authentication information DB 408, the processing proceeds to step S1402, and when the authentication fails, the processing proceeds to step S1406 and an error is displayed. In step S1402, the CPU 211 determines whether or not the user is a user that the image forming apparatus 101 follows. Specifically, the authentication information management section 407 of the image forming apparatus 101 determines whether or not the user is a user that the image forming apparatus 101 follows by referencing the follow list DB 409.

If the result of this determination is that the user is not followed, the processing proceeds to step S1406, and an error is displayed, and if the user is followed, the processing proceeds to step S1403. In step S1403, the CPU 211 acquires the messages and comments of the followed user. Specifically the communication section 401 of the image forming apparatus 101 transmits a request requesting messages that the user registered to the cloud service server 131 according to an instruction from the microblog communication management section 402.

With this, the messages of the user that the image forming apparatus 101 follows are displayed on a Web page specific to the image forming apparatus 101. Next, the processing proceeds to step S1404, and the CPU 211 searches for a print request command from amongst the acquired user messages. Specifically, the print request detection section 411 of the image forming apparatus 101 searches for a print request command included in the messages.

If there is no more print request commands amongst the received messages, the processing proceeds to step S1405, and if there is a print request command, the processing proceeds to step S1407. In step S1405, the CPU 211 checks whether there is one or more print requests. Specifically, the print request detection section 411 of the image forming apparatus 101 searches for a print request command included in the messages and at the same time counts the number of occurrences of the print request command.

In the case where not a single print request is found, an error to this effect is displayed, and if a print request was found, something to the effect that detected print requests will be executed is displayed. Accordingly, if there is not a single print request, the processing proceeds to step S1406, and if there is one or more print requests the processing proceeds to step S1411. In step S1406, the CPU 211 displays an error. Specifically, screen display section 400 of the image forming apparatus 101 displays the error.

In this case, if the content to be displayed is an error display based on the result of step S1401, content to the effect of “the user could not be authenticated” is displayed. Also, if the error display is based on the result of step S1402, content to the effect of “Following of Mr. XX has not been registered. Please register the follow.”, for example, is displayed, and transition to a follow registration screen is made. Also, if an error display is performed based on a result of step S1405, content to the effect of “Mr. XX's print request could not be found. Please confirm that the access destination is correct.” is displayed. Next a UI by which an access destination can be entered is prepared and this flow completes. In step S1407, the CPU 211 acquires a comment made with respect to a message including a print request command or a comment. Specifically the print request detection section 411 of the image forming apparatus 101 acquires comments from a user or another image forming apparatus 101. Next, in the case of a comment from a user, the print request message section 411 searches for text for print cancellation, etc. and in the case where the comment is from another image forming apparatus 101, the print request message section 411 searches for text for print completion, etcetera. In a case where the result of this is that text for print cancellation by a user, or print completion by another image forming apparatus 101 exists, the print request found in step S1404 is ignored and processing proceeds once again to step S1404.

On the other hand, if text for print cancellation by a user, or print completion by another image forming apparatus 101 does not exist, the processing proceeds to step S1408. In step S1408, the CPU 211 acquires print data from the location that the user stored it to on the cloud service server 131. Specifically, the print request detection section 411 of the image forming apparatus 101 determines the storage location of the user print data, and notifies the print data management section 403. The print data management section 403 instructs the communication section 401 to acquire print data, and the communication section 401 acquires the print data from the location on the cloud service server 131 where the user stored it.

Next, the print data is stored in the print data DB 405, and something to the effect that it was stored is sent in notification to the job processing section 404. Next, the processing proceeds to step S1409, and the CPU 211 outputs the print data. Specifically, the job processing section 404 performs a print based on print data stored in the print data DB 405. When printing completes in this way the processing proceeds to step S1410, and the CPU 211 displays that print completed to the UI. Specifically the job processing section 404 notifies the microblog communication management section 402 of print output completion. Next the microblog communication management section 402 sends a notification to the cloud service server 131 of print completion via the communication section 401. Also, the screen display section 400 displays that the printing completed. Next, once again the processing proceeds to step S1404, and another message is searched to determine whether it includes a print request command. Also, in step S1411, the CPU 211 displays that processing completed for all of the print requests (print requests for which print completion notification has not been made). Specifically, the screen display section 400 of the image forming apparatus 101 displays that all of the print requests have been completed. Also, the microblog communication management section 402 notifies the cloud service server 131 that all of the print requests have been completed via the communication section 401. As explained above, by the third embodiment, by interpreting comments corresponding to a message, it is possible to avoid once again printing for a print request command for which printing has already completed.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-183585, filed Aug. 22, 2012, which is hereby incorporated by reference herein in its entirety.

What is claimed is:

1. An image processing apparatus capable of communicating with a server that provides a microblogging function, the image processing apparatus comprising:
an authentication unit configured to authenticate a user;
an acquisition unit configured to acquire, in accordance with an authentication of the user by the authentication unit, a message registered on the server by the user authenticated by the authentication unit;
a determination unit configured to make a determination as to whether or not the message acquired by the acquisition unit requests processing of image data; and
a processing unit configured to process, in a case where the result of the determination by the determination unit is that the message acquired by the acquisition unit requests processing of image data, the image data designated by the message.

2. The image processing apparatus according to claim 1, further comprising a receiving unit configured to receive, from the server, the image data designated by the message acquired by the acquisition unit.

3. The image processing apparatus according to claim 1, further comprising a registration unit configured to register, to the server, a comment that indicates that processing by the processing unit completed.

4. The image processing apparatus according to claim 1, wherein the processing unit includes a printing unit configured to print the image data.

5. The image processing apparatus according to claim 4, wherein the message includes a character string indicating a number of print copies, and the print unit prints the image data according to the number of print copies indicated by the character string.

6. The image processing apparatus according to claim 1, wherein the processing unit processes, in a case where a plurality of messages that request processing of image data are acquired, image data designated by each of the plurality of messages.

7. A method of controlling an image processing apparatus capable of communicating with a server that provides a microblogging function, the control method comprising:
authenticating a user;
acquiring, in accordance with an authentication of the user in the authenticating step, a message registered on the server by the user authenticated in the authenticating step;
determining whether or not the message acquired in the acquiring step requests processing of image data; and
processing, in a case where the result of the determination in the determining step is that the message acquired by the acquiring step requests processing of image data, image data designated by the message.

8. The control method according to claim 7, further comprising receiving, from the server, the image data designated by the message acquired in the acquiring step.

9. The control method according to claim 7, further comprising registering, to the server, a comment that indicates that processing in the processing step completed.

10. The control method according to claim 7, wherein the processing step includes printing of the image data.

11. The control method according to claim 10, wherein the message includes a character string indicating a number of print copies, and in the printing step the image data is printed according to the number of print copies indicated by the character string.

12. The control method according to claim 7, wherein in the processing step, in a case where a plurality of messages that request processing of image data are acquired in the acquiring step, image data designated by each of the plurality of the messages is processed.

13. A non-transitory computer-readable storage medium storing a program for causing a computer to function as the image processing apparatus according to claim 1.
